(19) United States
(12) Patent Application Publication
(10) Pub. No.: US 2006/0192526 A1
(43) Pub. Date: Aug. 31, 2006

(54) Charging device with a replaceable front panel

(75) Inventor: Chao-Chih Liu, Taichung (TW)

Correspondence Address: MERCHANT & GOULD PC, P.O. BOX 2903, MINNEAPOLIS, MN, 55402-0903, US

(73) Assignee: JUYE LII INTERNATIONAL CO., LTD., Taichung (TW)

(21) Appl. No.: 11/070,433

(22) Filed: Feb. 28, 2005

(51) Int. Cl. H02J 7/00

(52) U.S. Cl. 320/114

(57) ABSTRACT

A charging device includes a housing and a rail unit. The housing includes top and bottom panels, and a front panel. The top and bottom panels of the housing cooperatively define a front opening. The front panel of the housing serves to cover the front opening in the housing, and is coupled slidably and detachably to the top and bottom panels of the housing through the rail unit.

### BACKGROUND OF THE INVENTION

1. Field of the Invention

The invention relates to a charging device, more particularly to a charging device that includes a housing with a replaceable front panel.

2. Description of the Related Art

FIG. 1 illustrates a conventional charging device 1 that includes a housing 11, a charger (not shown), a dial 14, and an ampere meter 13. The housing 11 is formed by press stamping, and includes a front panel 111. The charger is mounted in the housing 11. The dial 14 and the ampere meter 13 are mounted on the front panel 111 of the housing 11.

The aforementioned conventional charging device 1 is disadvantageous in that the front panel 111 is irreplaceable.

### SUMMARY OF THE INVENTION

Therefore, the object of the present invention is to provide a charging device that includes a housing with a replaceable front panel.

According to the present invention, a charging device comprises a housing and a rail unit. The housing includes top and bottom panels, and a front panel. The top and bottom panels of the housing cooperatively define a front opening therebetween. The front panel of the housing serves to cover the front opening in the housing, and is coupled slidably and detachably to the top and bottom panels of the housing through the rail unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional charging device;

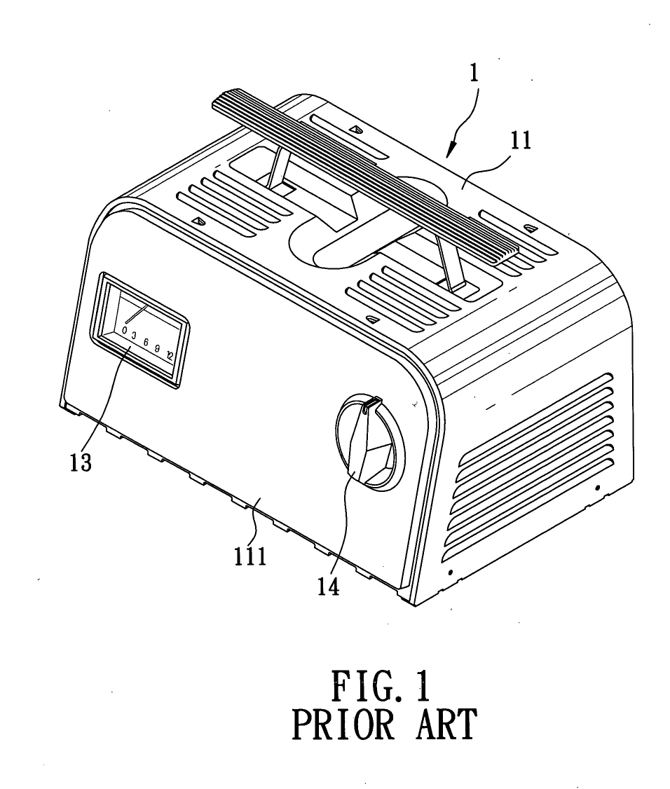

FIG. 2 is an exploded perspective view of the first preferred embodiment of a charging device according to the present invention;

FIG. 3 is a perspective view of the first preferred embodiment in an assembled state;

FIG. 4 is a partly sectional view to illustrate a rail unit of the first preferred embodiment;

FIG. 5 is an exploded perspective view of the second preferred embodiment of a charging device according to the present invention;

FIG. 6 is a perspective view of the second preferred embodiment in an assembled state; and

FIG. 7 is a partly sectional view to illustrate a rail unit of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

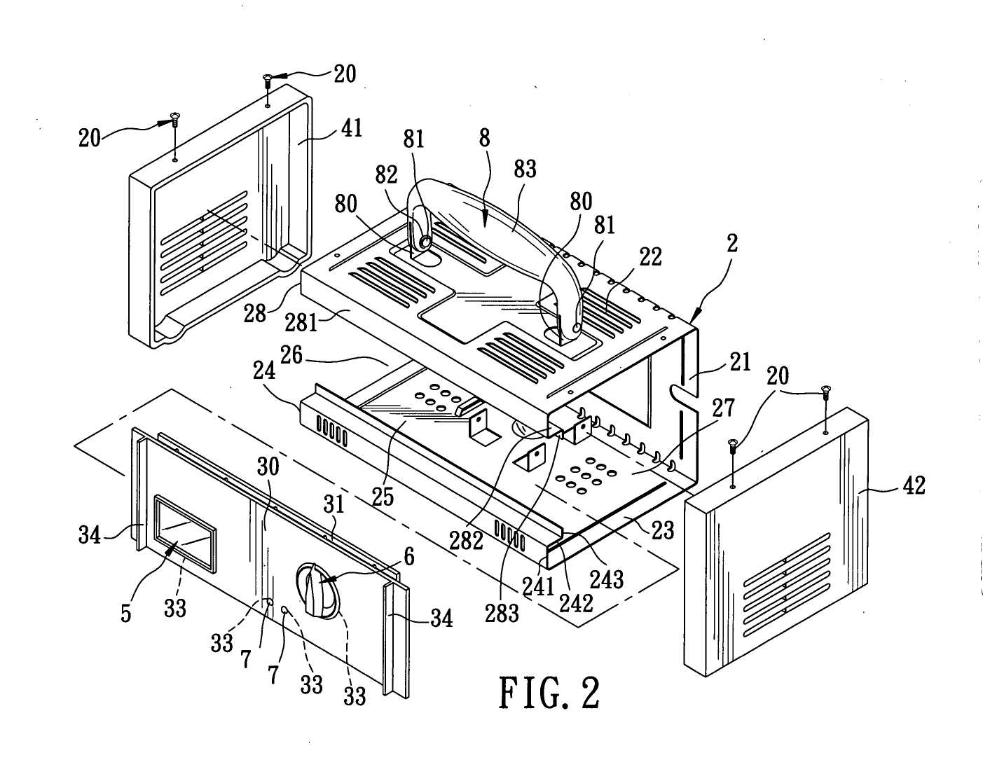

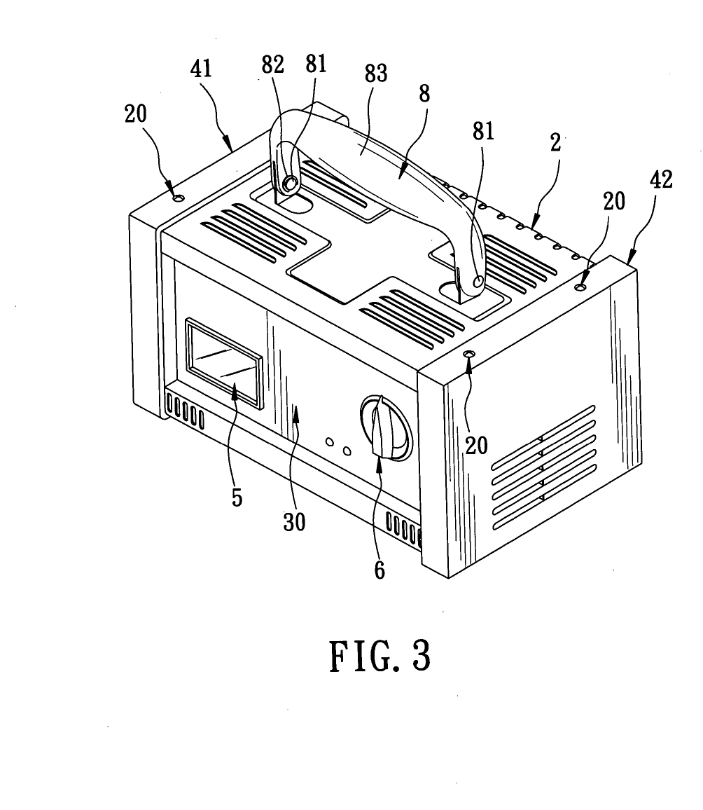

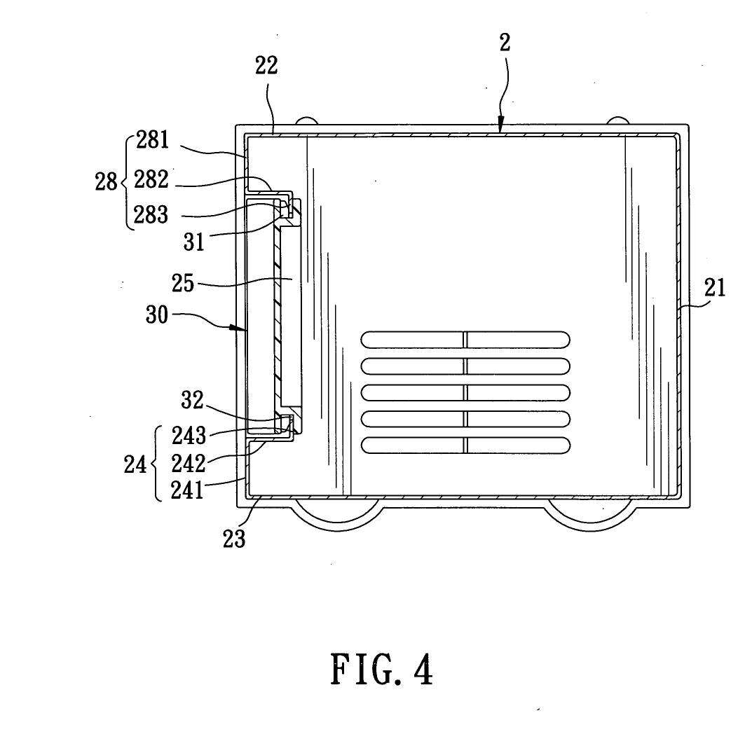

Referring to FIGS. 2 to 4, the first preferred embodiment of a charging device according to this invention is shown to include a housing 2 and a rail unit.

The housing 2 includes top and bottom panels 22, 23, left and right side panels 41, 42, and front and rear panels 30, 21.

Each of the top and bottom panels 22, 23 of the housing 2 has front and rear ends, and left and right ends. The front ends of the top and bottom panels 22, 23 of the housing 2 cooperatively define a front opening 25 therebetween. The rear panel 21 of the housing 2 interconnects the rear ends of the top and bottom panels 22, 23 of the housing 2. The left ends of the top and bottom panels 22, 23, and the rear panel 21 of the housing 2 cooperatively define a left opening 26 thereamong, whereas the right ends of the top and bottom panels 22, 23 and the rear panel 21 cooperatively define a right opening 27 thereamong. The front panel 30 of the housing 2 has top and bottom ends, each of which is coupled slidably and detachably to the front end of a respective one of the top and bottom panels 22, 23 of the housing 2 through the rail unit, in a manner that will be described hereinafter.

The rail unit includes a pair of rails 24, 28 and a pair of rail grooves 31, 32.

Each of the rails 28, 24 of the rail unit is formed on the front end of a respective one of the top and bottom panels 22, 23 of the housing 2. In particular, the rail 28 on the front end of the top panel 22 of the housing 2 includes a first rail part 281 that extends downwardly from the front end of the top panel 22 of the housing 2, a second rail part 282 that extends rearwardly from the first rail part 281 of the rail 28, and a third rail part 283 that extends downwardly from the second rail part 282 of the rail 28. The rail 24 on the front end of the bottom panel 23 of the housing 2 includes a first rail part 241 that extends upwardly from the front end of the bottom panel 23 of the housing 2, a second rail part 242 that extends rearwardly from the first rail part 241 of the rail 24, and a third rail part 243 that extends upwardly from the second rail part 242 of the rail 24.

Each of the rail grooves 31, 32 is formed in the top and bottom ends of the front panel 30.

The charging device further includes an ampere meter 5, a dial 6, and a pair of light-emitting diodes 7. The front panel 30 of the housing 2 is formed with a plurality of mounting holes 33 therethrough. Each of the dial 6, the ampere meter 5, and the light-emitting diodes 7 is mounted on the front panel 30 through a respective one of the mounting holes 33.

The charging device further includes a handle unit 8. In this embodiment, the handle unit 8 includes a pair of ears 80, each of which protrudes from an outer surface of the top panel 22 of the housing 2, a U-shaped handle 83 that is fastened pivotally to the ears 80 on the top panel 22 of the housing 2 with the use of a pair of pins 81 and a pair of C-clamps 82.

The charging device further includes a charger (not shown) mounted in the housing 2.

The housing 2 further includes a pair of left and right limiting members 34, each of which extends transversely from an outer surface of the front panel 30 of the housing 2.

To assemble, each of the rail grooves 31, 32 in the top and bottom ends of the front panel 30 of the housing 2 is first aligned to and engaged slidably along the third rail part 283, 243 of the rail 28, 24 on the front end of a respective one of the top and bottom panels 22, 23 of the housing 2 so as to cover the front opening 25 in the housing 2. The left and right side panels 41, 42 of the housing 2 are then positioned to cover the left and right openings 26, 27 in the housing 2, respectively, and abut against the left and right limiting members 34 on the outer surface of the front panel 30 of the housing 2, respectively. Thereafter, the left and right side panels 41, 42 of the housing 2 are fastened to the top panel 22 of the housing 2 with the use of screw fasteners 20. The construction as such permits the front panel 30 of the housing 2 to be replaced with different designs and configurations. Hence, different types of front panels may be mass produced, thereby reducing the manufacturing costs.

It is noted that the charger may be mounted in the housing 2 through the left opening 26 or the right opening 27 in the housing 2.

In an alternative embodiment, the left and right side panels 41, 42, the top and bottom panels 22, 23, and the rear panel 21 of the housing 2 may be formed integrally into a single piece.

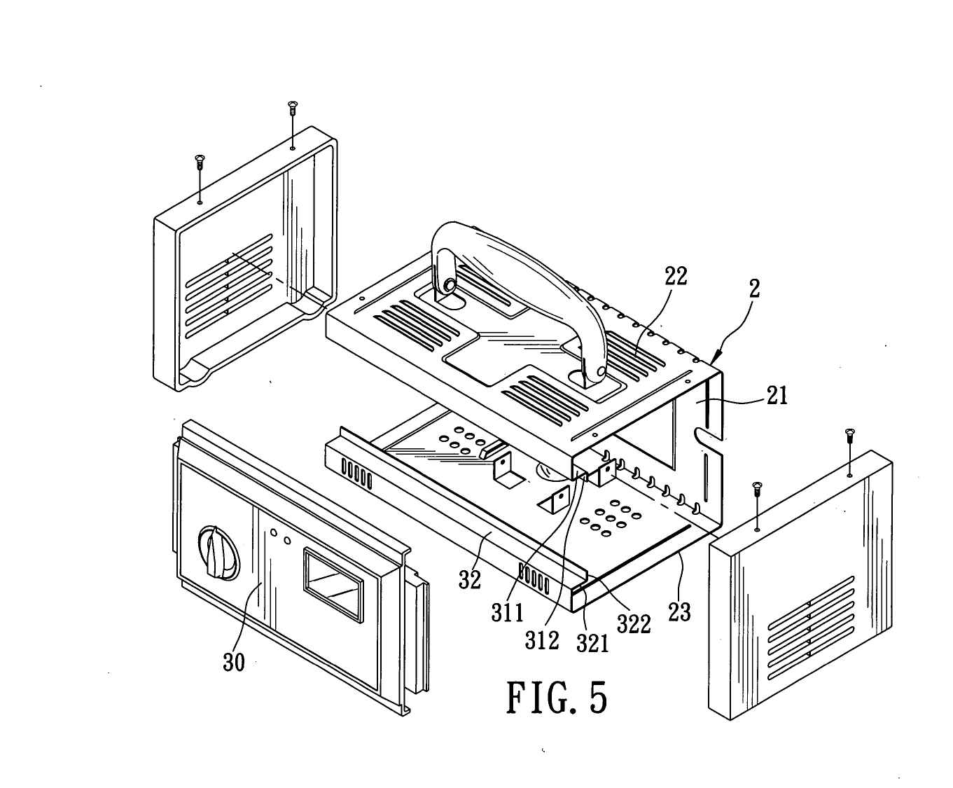

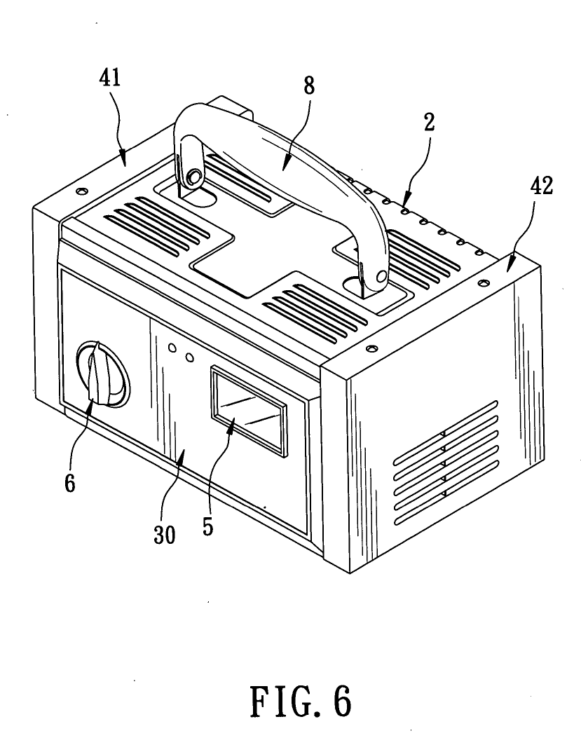

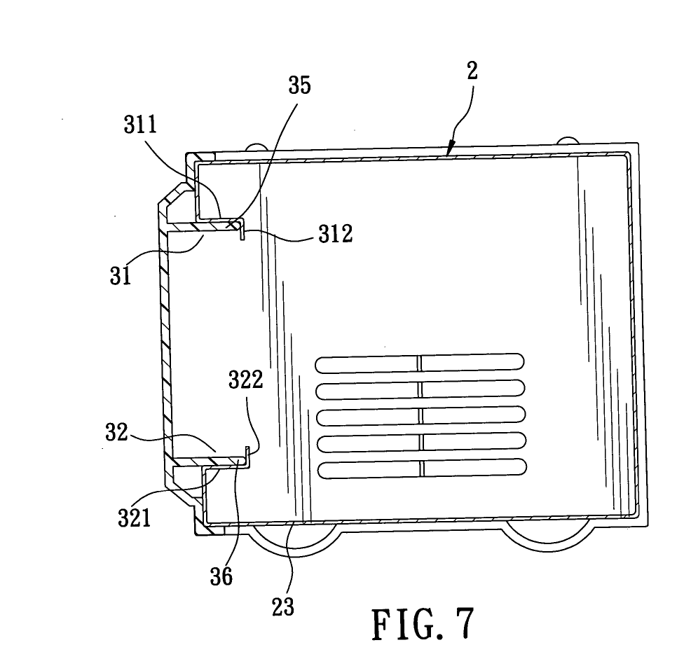

FIGS. 5 to 7 illustrate the second preferred embodiment of a charging device according to this invention. When compared with the previous embodiment, each of the rail grooves 31, 32 of the rail unit is formed in the front end of a respective one of the top and bottom panels 22, 23 of the housing 2. The rail groove 31 in the front end of the top panel 22 of the housing 2 is defined by a fist groove-defining wall that has a first wall portion 311 extending rearwardly from the front end of the top panel 22 of the housing 2, and a second wall portion 312 extending downwardly from the first wall portion 311 of the first groove-defining wall. The rail groove 32 in the front end of the bottom panel 23 of the housing 2 is defined by a second groove-defining wall that has a first wall portion 321 extending rearwardly from the front end of the bottom panel 23 of the housing 2, and a second wall portion 322 extending upwardly from the first wall portion 321 of the second groove-defining wall. Each of the rails 35, 36 is formed on a respective one of the top and bottom ends of the front panel 30.

Since assembly of the charging device of this embodiment is similar to that of described hereinabove in connection with the charging device of the previous embodiment, a detailed description of the same will be dispensed with herein for the sake of brevity.

While the present invention has been described in connection with what is considered the most practical and preferred embodiments it is understood that this invention is not limited to the disclosed embodiments but is intended to cover various arrangements included within the spirit and scope of the broadest interpretation so as to encompass all such modifications and equivalent arrangements.

What is claimed is:

1. A charging device, comprising:
a housing including
top and bottom panels cooperatively defining a front opening therebetween, and
a front panel for covering said front opening in said housing; and
a rail unit;
wherein said front panel of said housing is coupled slidably and detachably to said top and bottom panels of said housing through said rail unit.

2. The charging device as claimed in claim 1, wherein said housing further includes a rear panel that interconnects said top and bottom panels of said housing.

3. The charging device as claimed in claim 2, wherein said top and bottom panels, and said rear panel cooperatively define left and right openings, said housing further including left and right side panels, each of which covers a respective one of said left and right openings.

4. The charging device as claimed in claim 1, wherein said rail unit includes
a pair of rail grooves formed in said front panel; and
a pair of rails, each of which is formed on a respective one of said top and bottom panels of said housing, said rail on said top panel of the housing including a first rail part that extends downwardly from said top panel of said housing, a second rail part that extends rearwardly from said first rail part of said rail, and a third rail part that extends downwardly from said second rail part of said rail, said rail on said bottom panel of said housing including a first rail part that extends upwardly from said bottom panel of said housing, a second rail part that extends rearwardly from said first rail part of said rail on said bottom panel, and a third rail part that extends upwardly from said second rail part of said rail on said bottom panel of said housing.

5. The charging device as claimed in claim 1, wherein said rail unit includes
a pair of rails, each of which is formed on said front panel of said housing; and
a pair of rail grooves, each of which is formed in a respective one of said top and bottom panels of said housing, said rail groove in said top panel of the housing being defined by a first groove-defining wall that has a first wall portion extending rearwardly from said top panel of said housing, and a second wall portion extending downwardly from said first wall portion of said first groove-defining wall, said rail groove in said bottom panel of said housing being defined by a second groove-defining wall that has a first wall portion extending rearwardly from said bottom panel of said housing, and a second wall portion extending upwardly from said first wall portion of said second groove-defining wall.

6. The charging device as claimed in claim 1, wherein said front panel of said housing is formed with a pair of mounting holes therethrough, said charging device further comprising a dial and an ampere meter, each of which is mounted on the front panel through a respective one of said mounting holes.
